(19) United States
(12) Patent Application Publication
(10) Pub. No.: US 2023/0112233 A1
(43) Pub. Date: Apr. 13, 2023

(54) Grain Boundary Engineering in Additive Manufacturing

(71) Applicant: Texas Research International, Inc., Austin, TX (US)

(72) Inventors: Satish S. Rajaram, Austin, TX (US); Mark Warchol, Austin, TX (US); Brian Wisner, Athens, OH (US); Nathaniel McNees, Athens, OH (US)

(21) Appl. No.: 17/963,019

(22) Filed: Oct. 10, 2022

Related U.S. Application Data
(60) Provisional application No. 63/254,280, filed on Oct. 11, 2021.

(51) Int. Cl. B22F 10/50; B33Y 30/00; B33Y 50/00; B22F 10/80; B22F 12/90; B22F 12/00

(52) U.S. Cl. CPC B22F 10/50; B33Y 30/00; B33Y 50/00; B22F 10/80; B22F 12/90; B22F 12/222

(57) ABSTRACT

A low-cost ultrasonic system and method that can be used during powder based fusion additive manufacturing to control the microstructural features of parts built in a metallic system. The system and method include the application of laser acoustic emission technology to monitor the metallic microstructure during a build. The system and method can be built into or added onto existing laser-based powder based fusion additive manufacturing machines.

### CROSS REFERENCE

Priority is claimed from U.S. application 63/254,280 filed Oct. 11, 2021, which is hereby incorporated by reference.

### FIELD

This disclosure relates to the use of additive manufacturing, sometimes referred to as layer wise manufacturing, in the manufacture of metal parts.

### BACKGROUND

One way the mechanical behavior of metallic systems is controlled microstructurally is by grain boundaries which can be characterized by grain size, shape, and orientation, alongside the structure and property of constituent grain boundaries. While traditional metallurgical routes to strengthen metals often result in reduced ductility, recent studies have shown materials with engineered gradient microstructures achieve both high strength and ductility. However, these approaches require tooling or surface mechanical treatment which may not be possible based on geometry or accessibility to the part.

An alternative to traditional manufacturing methods is additive manufacturing, a layer-by-layer fabrication of complex 3D structures that can be used for several materials including ceramic, polymer, and metallic structures. The flexibility of additive manufacture allows for repairs of components, generating complex internal features such as hollow or lattice structures, efficient use of resources, reduction in production time, and is scalable.

Wang et al. [“Additively manufactured hierarchical stainless steels with high strength and ductility,” Nat. Mater., vol. 17, no. 1, pp. 63-70, 2018.] demonstrated that laser powder-bed-fusion technique for additive manufacturing can be used to produce 316L Stainless Steel with an exceptional combination of strength and ductility compared to traditional manufacturing processes.

One of the primary challenges in implementing additive manufacturing metal parts is the challenge of achieving desired material properties. Studies have shown that metallic parts made by metal additive technologies have a significant variation in mechanical properties that can make additive manufacturing parts unreliable due to unacceptable variations. The layer-by-layer approach used in additive manufacturing leads to variability in mechanical behavior due to microstructural changes within the material. For example, in a fusion-based additive manufacture process, the solidification process can lead to the formation of columnar grains along the build direction, which causes material property anisotropy and degradation in mechanical performance.

In laser powder bed fusion additive manufacturing, it is common to reuse the powder in consecutive cycles for greater sustainability and cost effectiveness. There is a great deal of interest in understanding the influence of reusing powder on the additive manufacturing process, particularly if it can be done in real-time with in-situ monitoring. Characterizing the material quality in-situ as it is deposited and solidified offers a critical means to aid additive manufacturing methods as the identification of relevant signals can provide more insight into the build that could be used to develop more reliable and cost-efficient parts. Work by Taheri et al. [“Revealing the Effects of Powder Reuse for Selective Laser Melting by Powder Characterization,” Jom, vol. 71, no. 3, pp. 1062-1072, 2019], demonstrates the potential of acoustic emission for in-situ monitoring of various additive manufacturing processes. Using a k-means clustering algorithm, the authors were able to classify acoustic signatures by the type of manufacturing process used. To gain more flexibility during in-situ monitoring, acoustic signatures can be detected using laser acoustic emission. Laser acoustic emission offers the ability to monitor additive manufacturing in-situ, as the laser sensor can be changed in real-time to monitor regions of interest based on the desired geometry and compared back to fixed referenced acoustic emission sensors and/or baseline signals. Utilization a non-contact approach to monitor the build process using laser acoustic emission presents an opportunity to make real-time corrections of the build and understand part quality without excessive post manufacturing inspections.

To develop additive manufacturing parts with more predictable and reliable behavior, there is a need to actively control the microstructural features of a given material system, e.g., grain boundaries. The application of ultrasound to the processing of liquid or semi-liquid metal alloys during casting, referred to as ultrasonic melt treatment, is known to effectively alter microstructures during casting to improve mechanical behavior. This process involves using an ultrasonic source to induce cavitation bubbles in acoustic streams of processed liquids, which can alter grain characteristics (size, shape, morphology, etc.)

Recently, features of the ultrasonic melt treatment process have been extended to additive manufacturing, as in Todaro et al. [C. J. Todaro et al., “Grain structure control during metal 3D printing by high-intensity ultrasound.,” Nature Communications., vol. 11, no. 1, p. 142, 2020.] In their work the authors demonstrate how ultrasound can be used to alter columnar microstructures containing grain boundaries from columnar to equiaxed within Ti-6Al-4V (Ti64) during laser powder deposition additive manufacturing. These changes resulted in an increase in yield and tensile strengths by 12%. Their results were extended to an Inconel 625 sample, demonstrating how ultrasound can be cycled on and off during the build process to alter microstructural features in specific areas of the build. Their work demonstrates the viability of using ultrasound in tandem with additive manufacturing to refine microstructural features. However further investigation is clearly needed as Todaro et al focused on Directed Energy Deposition as the additive manufacturing technology and focused on building parts directly on the sonotrode, or ultrasound source rather than a build plate.

Directed Energy Deposition covers a range of terminology: ‘Laser engineered net shaping, directed light fabrication, direct metal deposition, 3D laser cladding’ It is a more complex printing process commonly used to repair or add additional material to existing components (Gibson et al., 2010).

A typical Directed Energy Deposition machine consists of a nozzle mounted on a multi axis arm, which deposits melted material onto the specified surface, where it solidifies. The process is similar in principle to material extrusion or another additive manufacturing technique known as fused deposition modeling. But the nozzle can move in multiple directions and is not fixed to a specific axis. The material, which can be deposited from any angle due to 4 and 5 axis machines, is melted upon deposition with a laser or electron beam. The process can be used with polymers, ceramics but is typically used with metals, in the form of either powder or wire.

But importantly the installed base of metal machines is largely not Directed Energy Deposition, but utilize Powder Bed Fusion technologies, which include the following commonly used additive manufacturing techniques: direct metal laser sintering (DIALS), electron beam melting (EEM), selective heat sintering (SHS), selective laser melting (SLM) and selective laser sintering (SLS). Therefore, there is a need to transition ultrasonic grain refinement techniques to Powder Bed Fusion additive manufacturing approaches. In addition, the production of metal parts directly on a sonotrode is limiting due to the size and limited understanding of what differences will occur if the sonotrode is not of the same material as the metal powder being used.

Thus, there is a need for new approaches that can address these issues.

### BRIEF DESCRIPTION OF THE DRAWINGS

FIG. 1 illustrates a traditional configuration for a powder bed fusion additive manufacturing machine which shows the basics of selective laser sintering (SLS) but could also represent direct metal laser sintering (DMLS), and other powder bed fusion variants.

FIG. 2 illustrates one possible configuration of a direct metal laser sintering machine equipped with a build plate onto which the parts are built, and with that build plate having an ultrasonic array of transducers. Also illustrated is a laser acoustic emission (LAE) system used during the build to monitor in-situ acoustic signals to characterize the metallic microstructure.

FIG. 3 illustrates a possible alternate configuration to FIG. 2 in which any array of transducers is replaced by one large sonotrode directly under the build plate for providing acoustic energy into the build plate during the manufacture of the part.

### BRIEF SUMMARY

This description proposes a low-cost ultrasonic system that can be used during laser-based powder bed fusion additive manufacturing to control microstructural features of a metallic system. The system described can be built into or added onto existing laser-based powder based fusion additive manufacturing machines. During the additive manufacturing process, laser acoustic emission is used to monitor the build and characterize the metallic microstructure. The system can induce a wide range of ultrasonic frequencies during the additive manufacturing process to determine how variations in frequency can alter grains of a given metallic microstructure. Measurements will quantify differences in microstructural and mechanical behavior of samples created under the same conditions to understand variability of producing samples using ultrasonics and additive manufacturing and changes to the re-usability of powder in builds.

This description also proposes a method for applying ultrasound energy in a laser-based powder bed fusion additive manufacturing build method and a method for using laser acoustic emission methods to monitor in-situ acoustic signals to characterize the metallic microstructure during a build.

Rather than attempt to build parts directly onto a sonotrode the approach described herein builds parts onto the “traditional” metal build plate often used in direct metal laser sintering and then couples the ultrasonic power directly to the build plate from beneath the build plate. Several embodiments have been identified. A single large sonotrode beneath the plate is one embodiment, but multiple ultrasonic transducers could be placed strategically beneath the build plate. In no case would it be required to build parts directly on the sonotrode.

The marketplace need can thus be met by an ultrasonic system used during laser-based powder bed fusion additive manufacturing to control microstructural features of a metallic system including at least a laser based powder bed fusion additive manufacturing system for building parts within a build chamber in a layer wise manner; a laser acoustic emission system within said additive manufacturing system used to monitor the build in real time and characterize the metallic structure; a metallic build plate onto which the metallic powders are sequentially deposited and uniformly leveled; a build laser and accompanying scanner system within said within said additive manufacturing system that sinters or melts the powder of that layer at the exact positions required to generate the part; a piston system below the build chamber that lowers the build chamber one layer at a time. ultrasonic transducers below and in contact with the build chamber for providing acoustic energy into the build plate during part manufacture.

### DETAILED DESCRIPTION

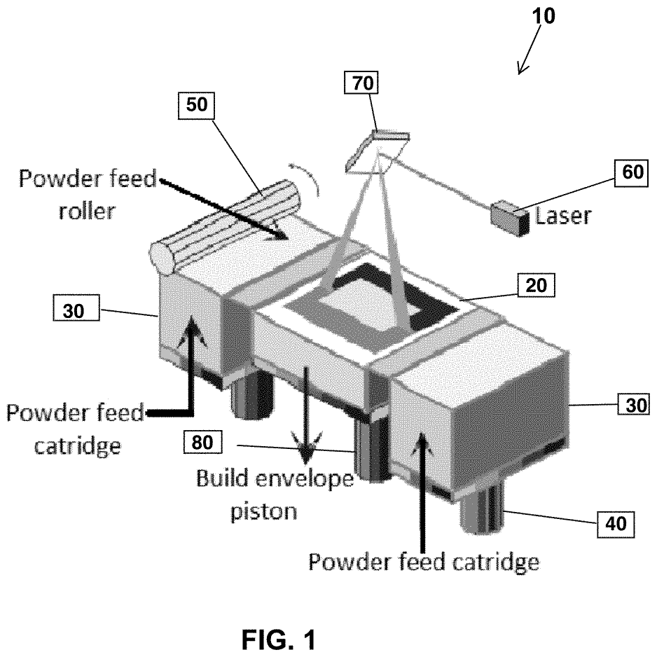

With regard to laser-based powder bed fusion technologies there are a number of variations but looking at FIG. 1 a typical configuration that is similar to the original selective laser sintering is shown generally as 10. A central build chamber 20 contains the powder bed where the part is manufactured by layer wise manufacturing. On either side of that central build chamber are powder feed cartridges 30 initially filled with the feed powder. Powder is fed successively from each side by slightly raising feed pistons 40 under each feed cartridges, which creates a small mound of power that is successively fed and leveled across the build chamber. After each layer of powder is added on top of the build by a powder feed roller 50 the laser 60 that sinters or melts the powder of that layer is directed to the exact positions required to generate the part by a scanner system 70. After the laser finishes its pass a piston 80 under the build chamber moves down one layer in preparation to receive the next layer of powder. In the example shown the spreading mechanism is a powder feed roller, usually a counter-rotating roller, but other spreading techniques such as a blade can be used.

In the direct metal laser sintering technologies that are being addressed in this application the powder is of course metal and there is usually a metal build plate that the first layers of the part are attached to.

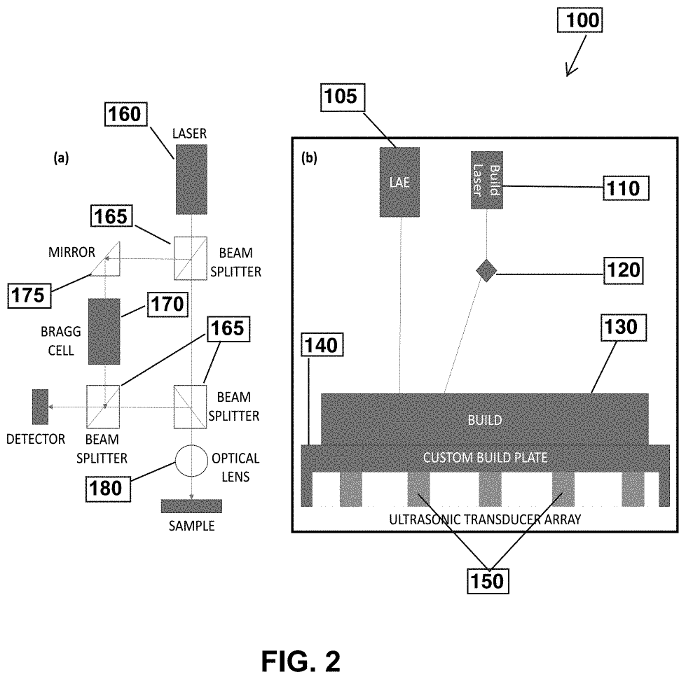

Turning now to FIG. 2, illustrated generally as 100, we illustrate a possible laser-based powder bed fusion system FIG. 2(b) with an included laser acoustic emission capability 105 that as mentioned earlier offers the ability to monitor the additive manufacturing process in-situ as the laser sensor can be changed in real-time during the build to monitor regions of interest based on the desired geometry with the data compared to fixed acoustic emission sensors. In this way we can reliably detect and understand acoustic emission signatures real-time which can make it possible to produce complex or out of production parts with different geometries via additive manufactured without the need to modify physical sensors.

The build laser 110 operating through a laser scanner 120 to sinter or melt the powder of each layer of the build 130 and the build proceeds by adding layers of powder (not shown) but described in FIG. 1. In this illustration the build layer rides on a metal build plate 140 as described in FIG. 1. Beneath the build plate and attached to it is shown one possible configuration of an array of ultrasonic transducers 150 used to provide the acoustic energy to the build. There are several potential transducer configurations, each of which might be optimized for different metal systems. It is important that the contact between the transducers and the build plate adjusted to maintain enough contact between the two.

The laser acoustic capability 105 can take a number of forms schematically but an example LAE capability is shown in (a) of FIG. 2. In this approach the LAE system has three beam splitters 165 and a mirror 175 which operate to split the laser 160 beam and feed part of it through an optical lens and part through a Bragg cell 170, after which it is fed to a detector. This is a standard configurator of a vibrometer used to detect fluctuations in surface position compared to a reference.

The LAE sends a signal to the build plate before printing to detect vibrations from the ultrasonic transducer. The frequency of the signal is examined and the bolts on the corners of the build plates are tightened until the signal frequency matches the frequency sent to the transducer. This validates that the build plate has been tightened correctly and sufficient vibration is provided to induce wave streaming or cavitation. The LAE laser does not have to be perpendicular to the build plane but should be in the same area as the build to validate the correct energy is being sent.

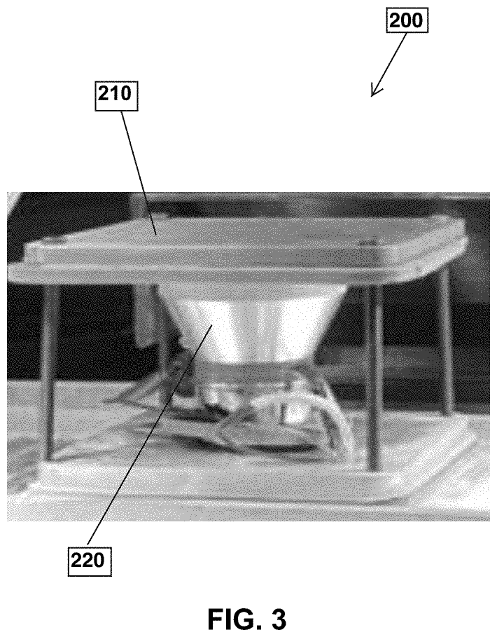

FIG. 3 illustrated generally as numeral 200 is another possible configuration, which is simply one very large sonotrode 220 placed below the build plate 210 to provide maximum acoustic energy.

We have physically demonstrated the viability of using several of these combinations of transducers/sonotrodes operating below a metal build plate to refine the microstructural features of parts created in powder bed fusion machines.

Although certain embodiments and their advantages have been described herein in detail, various changes, substitutions, and alterations could be made without departing from the coverage. Moreover, the potential applications of the disclosed techniques are not intended to be limited to the embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized.

1. An ultrasonic system used during laser-based powder bed fusion additive manufacturing to control microstructural features of a metallic system comprising:
a. a laser based powder bed fusion additive manufacturing system for building parts within a build chamber in a layer wise manner;
b. a laser acoustic emission system within said additive manufacturing system used to monitor the build in real time and characterize the metallic structure;
c. a metallic build plate onto which the metallic powders are sequentially deposited and uniformly leveled;
d. a build laser and accompanying scanner system within said within said additive manufacturing system that sinters or melts the powder of that layer at the exact positions required to generate the part;
e. a piston system below the build chamber that lowers the build chamber one layer at a time; and
f. ultrasonic transducers below and in contact with the build chamber for providing acoustic energy into the build plate during part manufacture.

2. The ultrasonic system used during laser-based powder bed fusion additive manufacturing to control microstructural features of a metallic system of claim 1 wherein the ultrasonic transducers below and in contact with the build plate is an ultrasonic array of transducers.

3. The ultrasonic system used during laser-based powder bed fusion additive manufacturing to control microstructural features of a metallic system of claim 1 wherein the ultrasonic transducers below and in contact with the build plate is a single large sonotrode of transducers.

4. The ultrasonic system used during laser-based powder bed fusion additive manufacturing to control microstructural features of a metallic system of claim 1 wherein the laser-based powder bed fusion additive manufacturing technology is selected from: direct metal laser sintering (DMLS), electron beam melting (EBM), selective heat sintering (SHS), selective laser melting (SLM) and selective laser sintering (SLS).

5. A method for using an ultrasonic system in laser-based powder bed fusion additive manufacturing to control microstructural features of a metallic system by:
a. providing a laser based powder bed fusion additive manufacturing system for building parts within a build chamber in a layer wise manner;
b. providing a laser acoustic emission system within said additive manufacturing system used to monitor the build in real time and characterize the metallic structure;
c. providing a metallic build plate onto which the metallic powders are sequentially deposited and uniformly leveled;
d. providing build laser and accompanying scanner system within said within said additive manufacturing system that sinters or melts the powder of that layer at the exact positions required to generate the part;
e. providing a piston system below the build chamber that lowers the build chamber one layer at a time;
f. providing ultrasonic transducers below and in contact with the build chamber for providing acoustic energy into the build plate during part manufacture.

6. The method of using an ultrasonic system in laser-based powder bed fusion additive manufacturing to control microstructural features of a metallic system of claim 5, further comprising: providing the ultrasonic transducers below and in contact with the build plate as an ultrasonic array of transducers.

7. The method of using an ultrasonic system in laser-based powder bed fusion additive manufacturing to control microstructural features of a metallic system of claim 5, further comprising: providing the ultrasonic transducers below and in contact with the build plate in a single large sonotrode of transducers.

8. The method of using an ultrasonic system in laser-based powder bed fusion additive manufacturing to control microstructural features of a metallic system of claim 5, wherein the laser-based powder bed fusion additive manufacturing technology is selected from: direct metal laser sintering (DMLS), electron beam melting (EBM), selective heat sintering (SHS), selective laser melting (SLM) and selective laser sintering (SLS).
